(19) United States
(12) Patent Application Publication
(10) Pub. No.: US 2013/0256421 A1
(43) Pub. Date: Oct. 3, 2013

(54) Electronic Transfer of Monetary Funds Using A Barcode Application

(71) Applicants: Keith Patrick Johnson, Shaker Heights, OH (US); Mark Reuben Sorrells, Glenwillow, OH (US)

(72) Inventors: Keith Patrick Johnson, Shaker Heights, OH (US); Mark Reuben Sorrells, Glenwillow, OH (US)

(21) Appl. No.: 13/430,751

(22) Filed: Mar. 27, 2012

(51) Int. Cl. G06Q 20/38; G06Q 40/00; G06K 19/06

(52) U.S. Cl. 235/494; 705/65; 705/35

(57) ABSTRACT

The electronic monetary transfer system uses a 2-Dimensional (2D) barcode. The service provider/inventors serve as a functionary for the transfer of monetary funds within the framework of several environments. One environment is defined as from one personal account holder to another personal account holder via a Smartphone. Another type of environment commonly referred to as point-of-sale (POS), is from one personal account holders Smartphone to a vendor/merchant account holder. The environments defined above don't represent the limits by which a monetary electronic transfer of funds using an electronic 2D barcode symbol will or could take place. The interface is a 2D time sensitive, pseudo-random barcode generated and uploaded to the requester's mobile device via a web-based application and is processed by an infrastructure similar to those used to support the processing of credit, debit and gift cards.

### BACKGROUND OF THE INVENTION

The embodiment of this invention is a system which allows the participants of a member's only association to have the liberty to transfer funds that is held by one member to another member via an electronic transfer. The invention fills a real-time void that exists currently in the financial services sector where the transfer of usable funds is accomplished within a limited network.

The invention offers a solution for individuals and merchants that desire to have the ability to secure funds in the event that one of the following circumstances occurs:

1. The member discovers that they have left their wallet or handbag at either home or somewhere and they don't have means for paying for a good or service while away from home.

2. The member discovers that they're unaware of the location of their wallet or handbag and are in need of immediate funds to negotiate their safe return home.

3. The member is traveling and the other means of payment are unavailable either via over-limit restrictions or insufficient funds.

4. The member is away from another member and the amount needed to complete specific transactions isn't at their immediate disposal.

5. The member has a request from another member within their immediate proximity to assist them with funds to complete a transaction.

6. The member would like to use this secure method to pay for goods or services in a retail environment.

7. The member prefers the option of carrying a medium for payment that doesn't leave their possession.

8. The merchant service member would allow members the option to pay for goods and service via this electronic symbol based medium.

In any of the above mentioned scenarios in which many individuals have encountered, the ability to have real-time access to funds to complete a transaction without leaving the immediate area is a resource our members will enjoy.

The method offers the end-user in this case our members the ability to carry upon there possession a medium (Smartphone and/or mobile computing devices) which allows them to access secured funds without having those funds on their person. Unlike a credit card, the electronic funds transfer system provides added level of security to the owner through user authorization to access their account. In the case of a lost or stolen credit card, which can be used at a number of locations before the cardholder realizes that the card is missing and is then able to cancel or suspend activity on the card. In the case of a lost or stolen, electronic cash flow members Smartphone, unauthorized usage is prevented through user authorization. This level of security will offer both our members and merchants a secure means of transacting the exchange of goods and services.

The current convention of presenting a card for payment, offers a minimum level of security. There are a number of methods implemented that have caused the user of this medium great discomfort due to theft and piracy. The current convention also opens the door for merchant service provider's employee's to become less efficient with completing transactions. In an environment where a swift processing of a sale will allow the merchant to capture a greater volume of customers, the current system has demonstrated a log-jam to swiftly processing transactions in certain environments.

The electronic cash transfer service offers its merchant members the ability to capture a greater number of customer transactions in a crowded environment due to the nature of using an electronic barcode and scanner to initiate and complete a transaction for goods and services. A member has the ability to present their code to the merchant and have the merchant member scanner their code which would subtract the amount being requested from the code presenting members account completing the transaction. By using a laser or optical scanner to process the transaction, the process can be completed in a remote location and at the click of the button.

The transaction using the electronic cash flow method is the most secure means of payment. With cash or credit cards, there is always the possibility of them being lost or stolen. With credit cards, there is the possibility of it not only being stolen but used by someone the cardholder unintended it to be used by. This would include someone that has gotten the numbers off the card and is using the card online to make purchases. The above mentioned scenarios aren't possible with an electronic cash transfer account member; the loss of their payment medium will not result in the loss of funds due to the illicit withdrawal of funds. Because the loss of the medium doesn't result in a loss of account funds, coupled with the device always in the member's possession makes it a more secure method of completing transactions for goods and services.

### BRIEF DESCRIPTION OF THE DRAWINGS

FIG. 1 is a flow diagram which identifies an operational scenario within the electronic funds transfer platform, call a local transfer. The drawing identifies the routing method for transferring funds from one member to another member on the network.

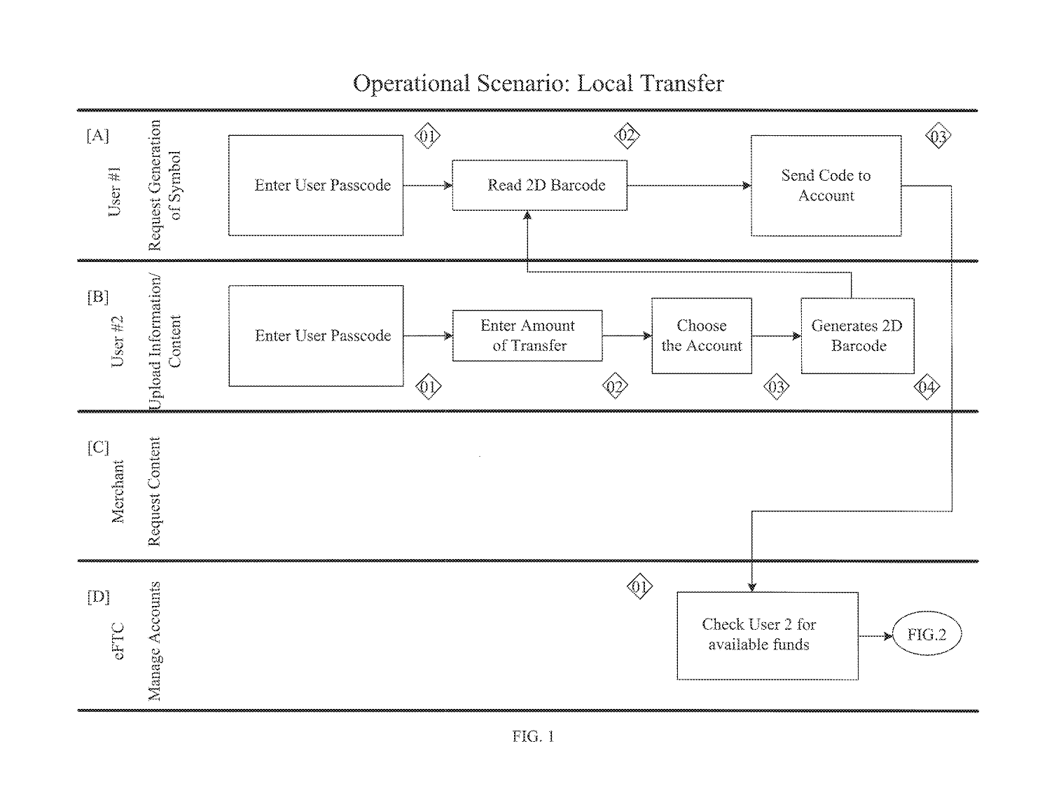

FIG. 2 is a continuation of FIG. 1 where the flow diagram identifies the process used to validate the availability of funds requested for transfer.

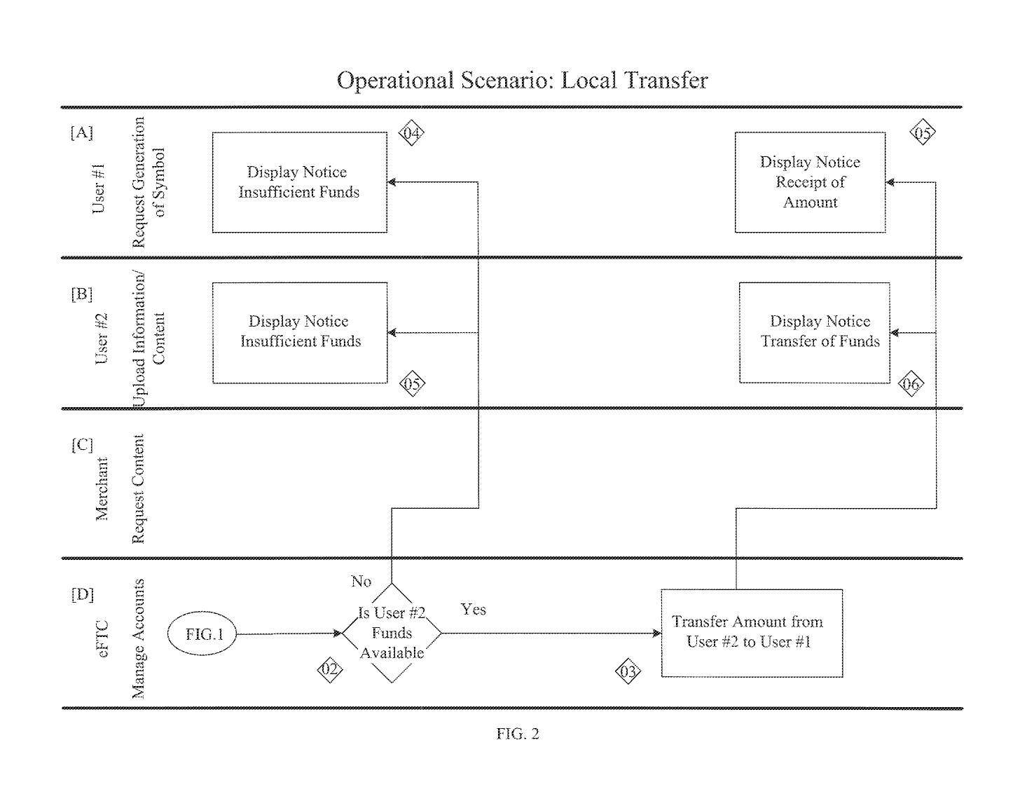

FIG. 3 is a flow diagram which identifies an operational scenario within the electronic funds transfer platform, called merchant payment. The drawing identifies the routing method for transferring funds to pay for goods and services held by a merchant account member.

FIG. 4 is a continuation of FIG. 3 where the flow diagram identifies the process used to validate the availability of funds requested for payment of goods and services.

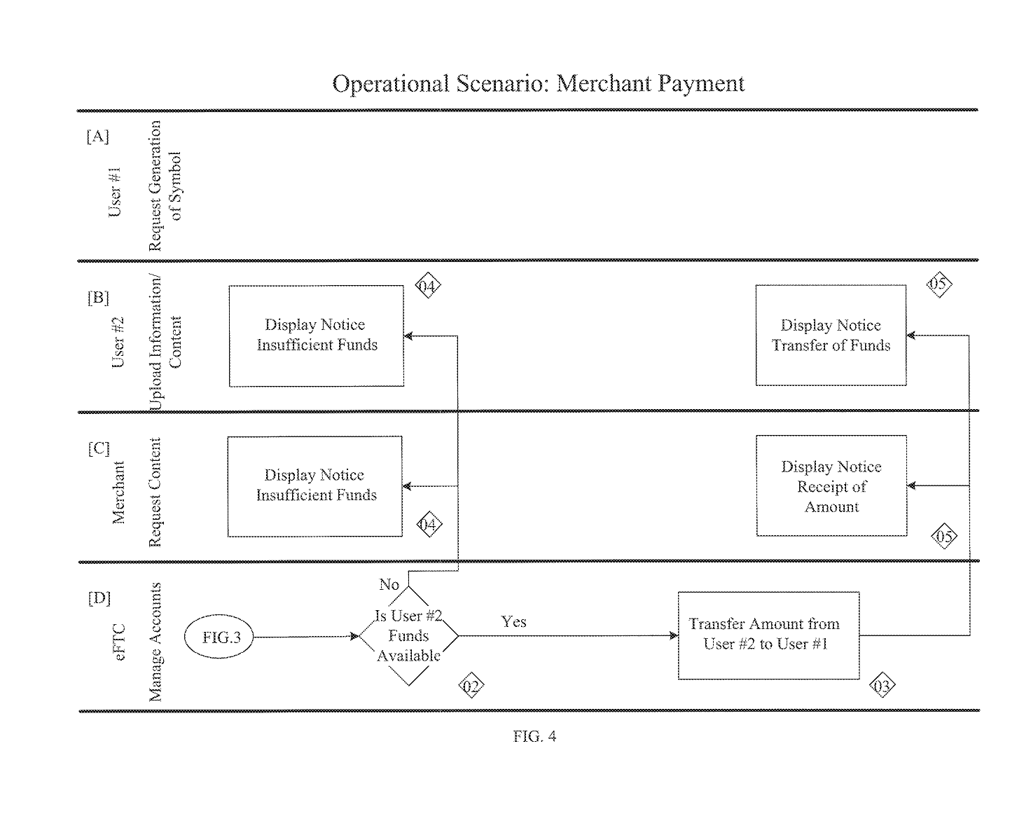

### DETAILED DESCRIPTION OF THE EMBODIMENT

1. See Attached FIG. #1.

The diagrams, FIGS. #1 & #2 are configured with swim-lanes which identifies the order of operation. This allows the reader a clear view of the operational flow of the Electronic Cash Transfer methodology and functionality.

2. See Attached FIG. #2

The claim is based on the development of a software based mobile application which has proprietary language. The sequences in which events occur within the code are unique to this mobile software application. The application employees a web-based medium for uploading the application to members mobile devices within the infrastructure established by the inventors of the application. Membership is obtained through a vetting process of a registration request from a non-member.

The infrastructure that supports the software application is identified in FIGS. #1 & #2. The infrastructure is based on a member's only model which gives the member opportunity to download the application to their mobile device. In FIG. #1, swim-lane [A] User #1, ‘Request Generation of a Symbol’, is the member that will receive funds upon request. User #1 is able to receive funds in a number of scenario's, which include local and remotely. In a local transfer scenario, the authentication and authorization process differ from a remote transfer. In a local transfer scenario, the member is able to communicate directly with the member account holder of the funds. In a remote scenario, User #1 submits a request for authentication after receiving an invitation to except funds sent by another member. In swim-lane [A, 01], the member must login with a unique passcode which when entered allows the member entry into the inventor's infrastructure. This passcode is the means by which User #1 is identified throughout and within the infrastructure.

In FIGS. #1 & #2, swim-lane [B] User #2, ‘Upload Information/Content’ is the member who will transfer funds from their account to User #1's, account. The request to transfer funds to another members account is sent to Electronic Fund Transfer Company (eFTC) by User #2. In swim-lane [B], User #2 enters their passcode [B, 01] which is their unique identifier within the infrastructure. Once within the infrastructure User #2, ‘Enter the Amount to be Transferred’ [B, 02] and selects the account from a preloaded list of account, ‘Choose the Account’, [B, 03] from which the funds will be taken and transferred. The member, User #2 presents the medium to User #1 ‘Generates a 2D Barcode’ [B, 04]. The generated 2D barcode is read by and sent to User #1 within the infrastructure of the EFT network

The User #1 member reads a message from member User #2, [A, 02] within the infrastructure that contains a message and a 2D barcode. The message is an invitation from User #2 to User #1 requesting a response of authentication, excepting funds in the amount identified by User #1. The level two security vetting for authorization of the request starts when the code sent to User #1, ‘Send code to account’, [A, 03] is sent by User #1 to eFTC the accounts manager.

The account manager, eFTC, upon receiving the request, ‘Checks User #2 account for available funds’, [D, 01]. The validation process takes minutes and is database driven which allows the members to complete transactions in real-time. Once eFTC, the account manager authenticates the amount [D, 02] and requesting members, User #1 & #2 will receive a message on their mobile device. The message will either state, to ‘Display notice of insufficient funds’, [A, 04], [B, 05]. If the funds are available the Transfer amount from User #2 to User #1 is completed [D, 03]. Once the transfer is completed by eFTC User #1 receives a message ‘Receipt of amount’, [A, 05] on their mobile device, User #2 also receives a message ‘Notice Transfer of Funds’, [B, 06].

Access to the funds by User #1 is time sensitive and based on the understanding that the parties are requesting this real-time transfer to remedy a real-time need for funds by another member within the network

The uniqueness of the claim is that the transfer of funds is accomplished electronically and that the medium where the funds land is a 2D barcode. The 2D barcode that User #1 now has is uploaded with information that allows a merchant member[C] to receive payment for goods or services via scanning the 2D symbol. The ability of a member to present their mobile device with an image of a 2D barcode displayed on the screen to a merchant is the bases of the patent application.

In the case of remote transfer, User #2, ‘Upload Information/Content’ and is the member who will transfer funds from their account to User #1's, account. After user authorization, User #2 requests funds through the account manager, Electronic Fund Transfer, to User #1. The account manager, eFTC, will send notification to User #1. User #1 upon receiving the request will view the notification, after user authorization will accept or reject the request. The eFTC will send notification to User #2, and also the reply to User #2 request. In the case where User #1 accepts request for funds, the eFTC will transfer funds from User #2 account into User #1 account.

### DETAILED DESCRIPTION OF MERCHANT PAYMENT OPERATION

3. See Attached FIGS. #3 & #4

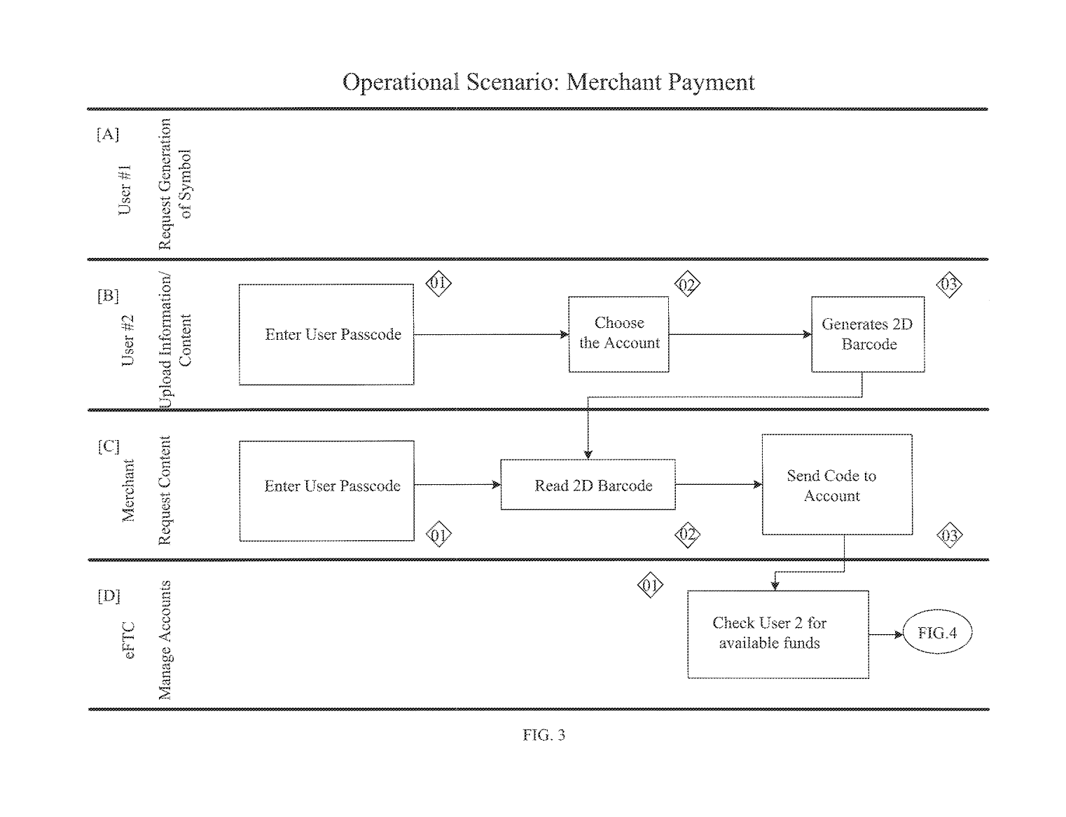

In the case Merchant Services in FIGS. 3 & 4, User #2, ‘Upload Information/Content’ is the member who will purchase goods or services for funds from Merchant. User #2 will present 2D Barcode as a form of payment. In swim-lane [B], User #2 enters their passcode [B. 01] which is their unique identifier within the infrastructure. Once within the infrastructure User #2, ‘Choose the Account’, [B, 02] from which the funds will be taken and transferred. The member, User #2 then selects the User #1 member account they would like to transfer the funds to, and ‘Generates a 2D Barcode’ [B, 03]. The generated 2D barcode is sent to User #1 within the infrastructure of the eFTC network.

The Merchant member reads a message from member User #2, [C, 02] within the infrastructure that contains a message and a 2D barcode. The message is an invitation from User #2 to Merchant requesting a response of authentication, excepting funds in the amount identified by Merchant. The level two security vetting for authorization of the request starts when the code sent to merchant, ‘Send code to account’, [C, 03] is sent by Merchant to eFTC the accounts manager.

The account manager, eFTC, upon receiving the request, ‘Checks User #2 account for available funds’, [D, 01]. The validation process takes minutes and is database driven which allows the members to complete transactions in real-time. Once eFTC, the account manager authenticates the amount [D, 02] and requesting members, Merchant and User #2 will receive a message. The message will either state, to ‘Display notice of insufficient funds’, [C, 04], [B, 04]. If the funds are available the Transfer amount from User #2 to Merchant is completed [D, 03]. Once the transfer is completed by eFTC Merchant receives a message ‘Receipt of amount’, [C, 05], User #2 also receives a message ‘Notice Transfer of Funds’, [B, 05].

Access to the funds by Merchant is time sensitive and based on the understanding that the parties are requesting this real-time transfer to remedy a real-time need for funds by another member within the network.

The uniqueness of the claim is that the transfer of funds is accomplished electronically and that the medium the funds land is a 2D barcode. The 2D barcode that Merchant now has is uploaded with information that allows a merchant member[C] to receive payment for goods or services via scanning the 2D symbol. The ability of a member to present their mobile device with an image of a 2D barcode displayed on the screen to a merchant is the bases of the patent application.

The inventors have identified one scenario in which the transfer of funds is accomplished. The infrastructure established by the inventor's accommodates various scenarios' in which the electronic transfer of funds is accomplished, therefore above illustration is to explain the methodology in its most simplistic form. The illustration outlined in this claim doesn't encompass the magnitude of scenarios this claim covers when referencing the transfer of funds from one account to another electronically with the expressed intent of using a symbol as a means of extracting the funds.

The inventors have identified three scenarios in which the transfer of funds is accomplished. The infrastructure established by the inventor's accommodates various scenarios' in which the electronic transfer of funds is accomplished, therefore above illustration is to explain the methodology in its most simplistic form. The illustration outlined in this claim doesn't encompass the magnitude of scenarios this claim covers when referencing the transfer of funds from one account to another electronically with the expressed intent of using a symbol as a means of extracting the funds.

1. The claim states a methodology of an encryption process that uses a time sensitive pseudo-random token approach to secure the transfer of funds between mobile devices.

2. The claim states that a functionary will handle the enrollment and transfer of account holders.

3. The claim states, the primary intent is the generation for presentation of a symbol in this claim a 2-dimensional (2D) barcode used as legal currency, expressly for the payment of goods and services.

4. The system for the electronic transfer of monetary funds according to claim 1 wherein, the process is implemented via a software application uploaded on an account holder's mobile device.

5. The system for the electronic transfer of monetary funds according to claim 3 wherein, the software application is a direct substitute for presenting a credit card, debit card, money wiring, or check as a form of payment for goods and services.

6. The system for the electronic transfer of monetary funds according to claim 1 wherein, the 2-dimensional (2D) barcode reader is integrated as a function of our software application which incorporates reading the (2D) code via an electronic image reader.
